(19) United States
(12) Patent Application Publication
(10) Pub. No.: US 2013/0076494 A1
(43) Pub. Date: Mar. 28, 2013

(54) Controlling Communication Device, Controlled Body Communication Device And Controlling Communication System

(71) Applicants: Takahiro Isono, Chiba (JP); Kota Toyotomi, Chiba (JP); Yasutaka Koike, Chiba (JP); Masahiro Tanaka, Chiba (JP)

(72) Inventors: Takahiro Isono, Chiba (JP); Kota Toyotomi, Chiba (JP); Yasutaka Koike, Chiba (JP); Masahiro Tanaka, Chiba (JP)

(73) Assignee: Futaba Corporation, Chiba (JP)

(21) Appl. No.: 13/612,141

(22) Filed: Sep. 12, 2012

(30) Foreign Application Priority Data
Sep. 22, 2011 (JP) 2011-207560

(51) Int. Cl. G05B 11/01

(52) U.S. Cl. 340/12.5

(57) ABSTRACT

In a controlling communication device, parameter of a device mounted in an airframe is modified remotely from a transmitting side without a personal computer or a dedicated setting box. The communication device is operable to select an operation mode and a parameter mode, and includes a controlling communication device (a transmitter) having a display, a controlled body communication device (a receiver) connected to a device mounted in the airframe. In the parameter mode, the parameter signal is transmitted to the receiver by operation of the transmitter, and the parameter of the device is modified remotely by radio while seeing the display. The parameter signal by return from the receiver notifies results of the modification. Even if the device is made plurally in types or in number, it is unnecessary to detach the device from the controlled communication device, so as to readily modify the parameter.

### TECHNICAL FIELD

This invention relates to an controlling communication system employed for a radio controlling of various models such as a helicopter, an airplane, a vehicle, and a ship, or an industrial machine that is operated unattendedly, in particular to an controlling communication system operable to remotely set and check parameter for a device installed in the controlled body, from the controlling communication device side by mutual communication between the controlling communication device an operator controls, the controlled body communication device installed in the controlled body.

### BACKGROUND ART

For example, mounted in a helicopter or an air plane as a controlled body that is controlled by radio are devices such as a servo motor or a gyroscope to control the controlled body, which controls radar, an elevator, an engine throttle, or a bias aileron. When the operator operates at a transmitter side a stick for control, an operation signal including operation data corresponding to an operation amount is transmitted to the controlled body. When a receiver that is installed in the controlled body then receives this signal, the operation data is applied to such the serve motor so that a controlled part is driven by the servo motor accurately by a requisite mount, allowing the controlled body to be controlled according to the operation by the operator of the transmitter side.

However, a user who possesses the controlling communication device for remotely controlling such the controlled device may, as necessary, change a parameter of the device such as the servo motor or the gyroscope, and change operation data according to the operation mount of the operational stick at the transmitter side, in order to correspond to usage circumference (weather or road condition) or to obtain desired operational feeling.

Known as means for changing the parameter of the device such the servo motor or the gyroscope mounted in the controlled body as mentioned above, is the invention recited in the after-mentioned PTL 1. The invention is related to a motor control device for radio control, using at least one of a plurality of operation channels in a radio control system for parameter setting in order to change parameter setting of the device using the transmitter, the parameter data to be set was sent through this channel to the receiver from the transmitter.

### CITATION LIST

### Patent Literature

### [PTL 1]

Japanese Patent Application Laid-Open Publication No. 6-312065

### SUMMARY OF INVENTION

### Technical Problem

However, the invention recited in the PTL 1 posed drawback that, of the limited numbers of operation channels that is included in the radio control system which communicates between the transmitter and the receiver, at least one operation channel is occupied for changing parameter of the device such as a servo motor mounted in a controlled body. Recently, varieties and a number of devices mounted in the controlled body tend to increase; thereby there are not as much allowance of the number of operation channels as enough; it is also undesirable that one operation channel is occupied for changing parameter of the device; and therefore an appropriate solution has been required.

Also, known as means of changing parameter of such the servo motor mounted in the controlled body in the radio control system are not only a device that transmits signal from a transmitter as described in the PTL 1, but a personal computer into which dedicated software is installed, or a programming box that is a dedicated device.

FIG. 6 shows what is called a “USB serial conversion adaptor” (hereinafter abbreviated as a conversion adaptor 20) which is employed when changing a gyroscope parameter using personal computer. An inlet 21 of the conversion adaptor 20 is connected with a USB port of the personal computer, a connection code 22 of the conversion adaptor 20 with gyroscope 30 that is disengaged from the controlled body, a power code 23 with a battery for a receiver or a power source of 5 volts. When a software for changing the gyroscope parameter, which has been preliminarily obtained and installed into the personal computer, is invoked in the personal computer through necessary operation, a setting screen for the parameter of the gyroscope 30 as shown in FIG. 7 is displayed on a display screen 40. There are various items as the parameter of a gyroscope 30 such as a flight mode or a servo mode, a gyroscope reverse, about which on the display screen 40 a desired value or selection are inputted so as to proceed to edit the parameter. Then after completing editing, pushing a write button 41 on the display screen 40 makes a parameter data that has been already edited enter into the gyroscope 30 through the conversion adaptor 20. Note that a read button 42 makes each parameter that has set in the gyroscope 30 read and displayed on the display screen 40 of the personal computer.

Note that the aforementioned programming box is a dedicated device of changing parameter in which software of changing device parameter is preliminarily installed, wherein when used, the parameter is set on the display screen after connected to such the gyroscope that is detached from the controlled body.

Notwithstanding, when changing setting of the device parameter on a field such an airport or a circuit where the controlled body is used, such the personal computer, the conversion adaptor or the programming box, when the aforementioned conversion adaptor 20 or programming box is used, is first required to convey to the field, which thus posed drawback that conveyance and preparation in the field were cumbersome. Also because the conversion adaptor 20 or the programming box that were connected with the personal computer is required to connect with wire to the device that was detached from the controlled body, workability becomes much cumbersome when adjusting the controlled body with the body flying or running that has already assembled. Namely, it is also required that after the device parameter is valued to change, while checking a state of the controlled body that is being controlled, the controlled body is moved near the operator; an objective device is detached from the controlled device so as to connect with the conversion adaptor 20 that is connected to the personal computer; then the parameter is changed as mentioned above; and after that, the device is again attached to the controlled device.

Therefore, the invention is made in view of the above drawbacks, with the object of setting and checking the parameter of the device installed in the controlled body, especially without using a personal computer or a dedicated device for setting by remote operation from a transmitter of the operator in order to operate the controlled body installed in a device operable to set a parameter.

### Solution to Problem

An controlling communication device of a first aspect, includes: (a) a controller operable to select a desired control mode from an operation mode for controlling a controlled body by controlling a device operable to set a parameter, and a parameter mode for managing the parameter of the device, wherein the device of the controlled device is mounted in the controlled body; (b) a transceiver transmitting an operation signal to the controlled body in the operation mode, and transmitting a parameter signal to, and receiving the parameter signal from, the controlled body in the parameter mode by control of the controller; and (c) an indicator indicating parameter information data in accordance with the parameter signal upon the controller in the parameter mode.

An controlling communication device of a second aspect is that in the controlling communication device of the first aspect, the parameter signal includes a write signal for transmitting the parameter information data destined to be set in the device of the controlled body to the controlled body, and a read signal for receiving the parameter information data set in the device of the controlled body from the controlled body.

A controlled body communication device of a third aspect, disposed in a controlled body in which a device operable to set a parameter is mounted, and connected to the device, includes: a controller identifying an operation data for controlling the controlled body or a parameter information data of the device for managing the parameter of the device; and a transceiver receiving an operation signal including the operation data, and transmitting and receiving a parameter signal including the parameter information data of the device by control of the controller.

A controlled body communication device of a forth aspect is that in the controlled body communication device of the third aspect, the parameter signal includes a write signal for receiving the parameter information data destined to be set in the device of the controlled body to the controlled body, and a read signal for transmitting the parameter information data set in the device of the controlled body from the controlled body.

An controlling communication system of the fifth aspect is that the controlling communication system controlling a device mounted in a controlled body and operable to set parameter so as to operate the controlled body, the controlling communication system includes: a) a controlling communication device including i) a controlling side controller operable to select a desired control mode from an operation mode for controlling the controlled body by controlling the device, and a parameter mode for managing a parameter of the device, ii) a transceiver transmitting an operation signal to the controlled body in the operating mode, and transmitting a parameter signal to, and receiving the parameter signal from, the controlled body in the parameter mode by control of the controlling side controller, and iii) an indicator indicating a parameter information data relevant to the parameter signal upon the controlling side controller in the parameter mode; and b) a controlled body communication system including iv) a controlled body side controller identifying an operation data of the controlled body relevant to the operating signal for controlling the controlled body, or a parameter information data relevant to the parameter signal for managing the parameter of the device; v) a controlled body side receiver receiving the operation signal from the controlling communication device, and transmitting the parameter signal to, and receiving the parameter signal from the controlling communication device by control of the controlled body side controller.

### Advantageous Effects of Invention

According to the controlling communication system of the first, second or third aspect, the controlling communication device composing the transmitter of the system, or the controlled body communication device composing the receiver of the system, either the operation mode of operating the controlled body, or the parameter mode of managing device parameter installed in the controlled body can be selected optionally by the controlling communication device side.

When selecting the operation mode, operation signal is transmitted to the controlled body communication body by operating of the controlling communication device to operate a device of the controlled body, allowing to operate the controlled body.

When selecting the parameter mode, if the device parameter installed in the controlled body is intended to manage (that is, change or check), operation of the controlling communication device makes parameter signal to be received from, or transmitted to the controlled bodies if necessary, and while checking the parameter that is shown on the display of the controlling communication device, the management work of the device parameter is operated remotely by radio. Therefore, if device that are installed in the controlled body is plural in type, or plural in number, there is no complexity to detach each device from the controlled body, or to connect each device via wire, respectively, and thereby it is made possible to check objective devices or parameters to manage on display at the controlling communication device side, for example, resulting in that management work for the parameter such as to change or check is made easy.

According to the controlling communication device composing the transmitter of the controlling communication system or the controlled body communication system composing the receiver of the same system of the second, third, or forth aspect, it is made possible to change parameters into new ones and to read and check parameters currently set in its parameter mode as managing work for parameters of the device installed into the controlled body communication device, each by operating the controlling communication device at the controlling communication device side.

Namely, when changing parameters as managing work of parameters, parameter data is displayed on the display by operating the controlling communication device to edit, the parameter signal including this parameter is transmitted to the controlled body communication device. Using the controlled body communication device, device parameter is changed by the parameter including the received parameter signal, and furthermore result of this editing work is transmitted to the controlling communication device to allow the operator to check the result of its editing work.

Also, when reading parameter from the transmitter as managing work, parameter signal commanding reading of the device parameter by the controlling communication device is transmitted to the controlled body communication device. The controlled body communication device reads the parameter of the specified device based on the received parameter signal, which is transmitted to the controlling communication device as the parameter signal. It is possible for the operator to check the read parameter on the display in the controlling communication device.

### BRIEF DESCRIPTION OF DRAWINGS

FIG. 1 is a block diagram illustrating a controlling communication system relevant to an embodiment of the present invention.

FIG. 2 is a conceptual diagram schematically illustrating a state of transmission and receipt of a parameter signal and modification thereof between a controlling communication device and a controlled body communication device upon changing parameter of the device in the controlling communication system relevant to the embodiment of the present invention.

FIG. 3 is a view illustrating a setting screen for the parameter that is displayed on a display in the controlling communication device upon changing parameter for a serve motor in the controlling communication system relevant to the embodiment of the present invention.

FIG. 4 is a view illustrating a setting screen for the parameter that is displayed on a display in the controlling communication device upon changing parameter for a gyroscope in the controlling communication system relevant to the embodiment of the present invention.

FIG. 5 is a flow chart illustrating operational procedure at each part upon changing the parameter of the device in the case of the controlling communication device being set in a parameter mode relevant to the embodiment of the present invention.

FIG. 6 is an outline view illustrating a state of a personal computer into which software for changing a parameter for a gyroscope is installed and a transforming adaptor are connected with the gyroscope.

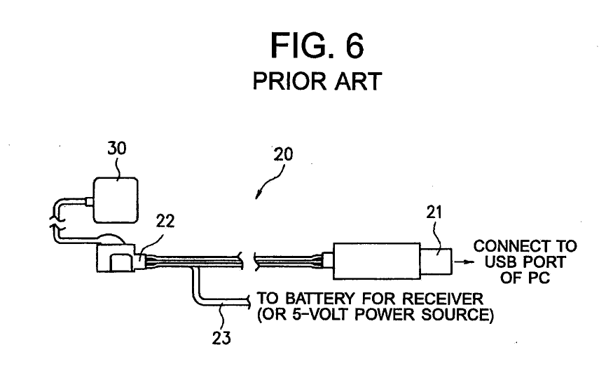

FIG. 7 is an view illustrating a setting screen of the parameter for the gyroscope that is indicated on the screen, when the personal computer into which a software for changing the parameter for the gyroscope is installed, and a transforming adaptor via the gyroscope shown in FIG. 6 are connected, and when the software in the personal computer is waked up.

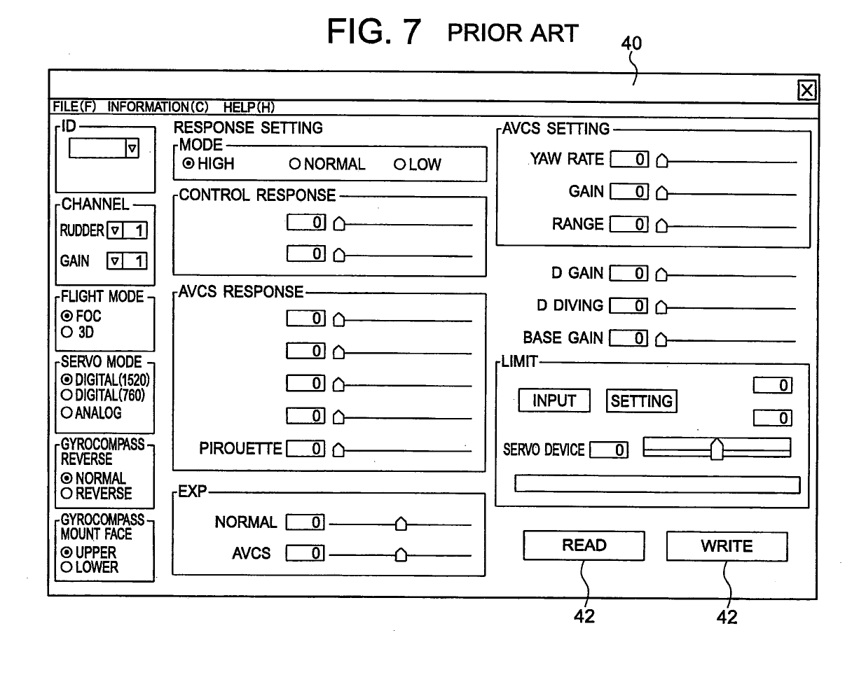

### DESCRIPTION OF EMBODIMENTS

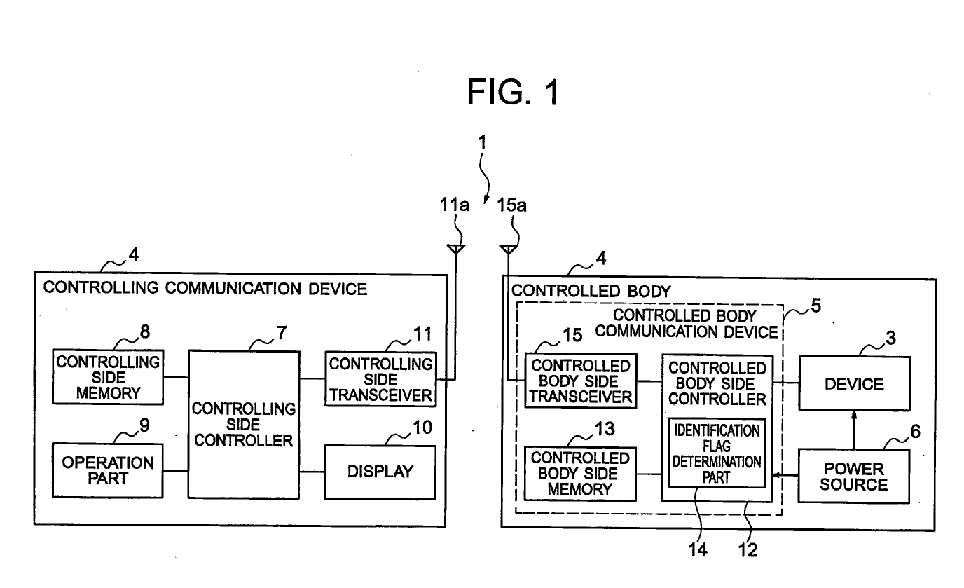

An embodiment of the present invention will be discussed with reference to FIGS. 1 to 5. FIG. 1 shows a block diagram of a controlling communication system 1 relevant to the present embodiment. The controlling communication system 1 of the present embodiment shown in FIG. 1 is composed of a transmitter and a receiver remotely controlling by radio a helicopter that is one example of the controlled body 2. Note that the controlled body 2 may be referred to as an airframe in the case of a helicopter or a plane, a car body in the case of an automobile, a vessel body in the case of a ship as well. Taken as an example for device 3 mounted in the helicopter as a controlled body 2, are an after-mentioned gyroscope, a servo motor, a GPS, and various types of censor for atmosphere pressure and temperature. These devices 3 include various parameters defining their operational performance, which are set into with any values for corresponding to usage atmosphere (that is, weather, or road condition) or obtaining desired controlling feelings, and are operable to modify. Types of specific parameters will be mentioned below in detail, but e.g., included in the case of the servo motor are speed control or adjust for steering angle and the like, in the case of the gyroscope sensitivity settings, calibration or so on. Also, the controlling communication system 1 provides control data or parameter information with these devices 3, and obtains control information including the parameter information and the like from these devices 3 so as to steer and control the helicopter.

As shown in FIG. 1, the controlling communication system 1 is composed of a controlling communication device 4, and a controlled body communication device 5. The controlling communication device 4 is what the operator controls manually. The controlled body communication device 5 is mounted in the controlled body 2. The controlled body communication device 5 is connected with the plurality of types of devices 3 mounted likewise in the controlled body 2, and is configured to control each device 3 by receiving signal from the controlling communication device 4 as mentioned below. Note that the plurality of devices 3 is shown entirely as a single block in FIG. 1. Also, mounted in the controlled body communication device 2 is a power source 6, which is connected with each device 3 and the controlled body communication device 5 so as to supply power thereto.

As shown in FIG. 1, the controlling communication device 4 includes a controlling side controller 7. The controlling side controller 7 controls overall each part of the controlling communication device 4; controls remotely each device 3 via the controlled body communication device 5; and is configured to selectively set desired mode according to its controlling purpose selected from two control modes of a control mode for controlling the controlled body 2 and a parameter mode for managing parameter of each device 3. The controlling side controller 7 is connected with a controlling side memory 8 in which program or data necessary to control is stored, a operation part 9 such as a switch or a switch for inputting information necessary to control, and a display 10 displaying information necessary to control. As mentioned below, when the controlling side controller 7 lies in the controlling mode, on the display 10 is displayed a control screen displaying each information that indicates a state of the controlled body 2 or information necessary to control, and when the controlling side controller 7 lies in the parameter mode, on the display 10 is displayed a parameter screen on which each information to be set into each device 3 is edited, and each parameter data set in each device 3 is displayed. Note that a touch switch displayed on the display 10 also serves as an operation part 9 for inputting data or command.

As shown in FIG. 1, the controlling side controller 7 is connected with a controlling side transceiver 11 having an antenna 11a. The controlling side transceiver 11, in the controlling mode, transmits controlling signal to the controlled body 2, which is controlled by the controlling side controller 7 inputted from the operation part 9, and receives each information indicating the state of the controlled body 2 transmitted from the controlled body 2, or in the parameter mode, it is possible to transmit or receive the parameter signal between itself and the controlled body 2.

As shown in FIG. 1, the controlled body communication device 5 mounted in the controlled body includes a controlled body side controller 12. The controlled body side controller 12 is connected with a controlled body side memory 13 in which program or various data necessary to control is stored. The controlled body side controller 12 controls overall each part of the controlled body communication device 5, and controls each device 3 using data transmitted from the controlling communication device 4. The controlled body side controller 12 includes an identification flag determination part 14 that identifies an identification flag in a packet composing data transmitted from the controlling communication device 4, and determines whether the data is the operation data or the parameter data. The controlled body side controller 12, when the data transmitted from the controlling communication device 4 is inputted, determines a type of the data by the identification flag determination part 14, and if the data involves the operation data, the controlled body side controller 12 makes the operation data applied to the device 3 to control the controlled body 2, or if the data involves the parameter data, the controlled body side controller 12 manages the parameter to make the parameter signal applied to the device 3 to modify the parameter or read the parameter set in the device 3.

As shown in FIG. 1, the controlled body side controller 12 is connected with a controlled body side transceiver 15. The controlled body side transceiver 15 receives the operation signal or the parameter signal transmitted from the controlling side transceiver 11 of the controlling communication device 4 so as to input the operation signal or the parameter signal to the controlled body side controller 12, and transmit signal or the parameter signal including various information indicating a state of the controlled body 2 to the controlling side transceiver 11 of the controlling communication device 4.

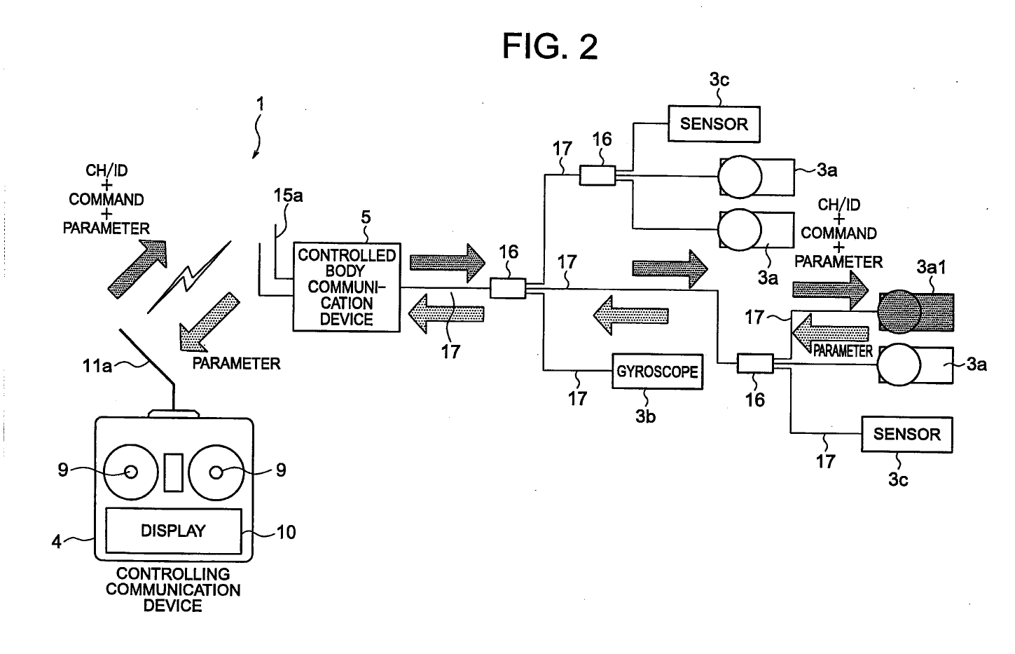

FIG. 2 shows a flow of signal or information in the controlling communication system 1 in which the communication device 4 is set in the parameter mode, when transmission and receipt of the parameter signal between the controlling communication device 4 and the controlled body communication device 5 re-writes a specific parameter of the specific servo motor. Hereinafter, with reference to FIGS. 1 and 2, write and read of the parameter in the parameter mode will be discussed.

As shown in FIG. 2, connected to the controlled body communication device 5 are a plurality of servo motors 3a as devices 3, a gyroscope 3, a plurality of sensors 3c with wires 17 distributed in a tree shape via a plurality of branches 16, classified according to applications and features.

As shown in part in FIG. 2, in the parameter mode, the parameter signal transmitted from the controlling communication device 4 to the controlled body communication device 5 is composed of ID information, an identification flag, specific information (CH/ID) of the device 3, command information, and parameter information. Note that in FIG. 2, the specific information (CH/ID), the command information, and the parameter information are only shown, and the others are omitted. The ID information is a specific data for the corresponding controlled body communication device 5, from which the controlling communication device 4 identifies the proper corresponding controlled body communication device 5 to transmit or receive. The identification flag is a data for identifying the operation signal and the parameter signal. The specific information of the device 3 is a data identifying the objective device 3 to supply the parameter signal, and is composed of a channel data (CH) as the information specifying the objective device 3, or the identification number (ID) of the objective device 3. The command information is a read or a write command indicating a command content, whereby in the read command, the parameter or the data is read from the device 3 designated by the identification data, and whereby in write command, the parameter is written to the device 3 designated by the identification data. The parameter information is what in the write command, is actually set (that is, written) to the specified device 3.

As shown in FIG. 2, in the controlling communication device 4 set in the parameter mode, the operator, seeing a parameter screen displayed in a display 10, identifies the device 3 to modify the parameter, and designates a parameter type to be next modified, and then inputs a changing parameter value. In the example in FIG. 2, a specific parameter for one specific servo motor 3a1 of the plurality of servo motors 3a is modified.

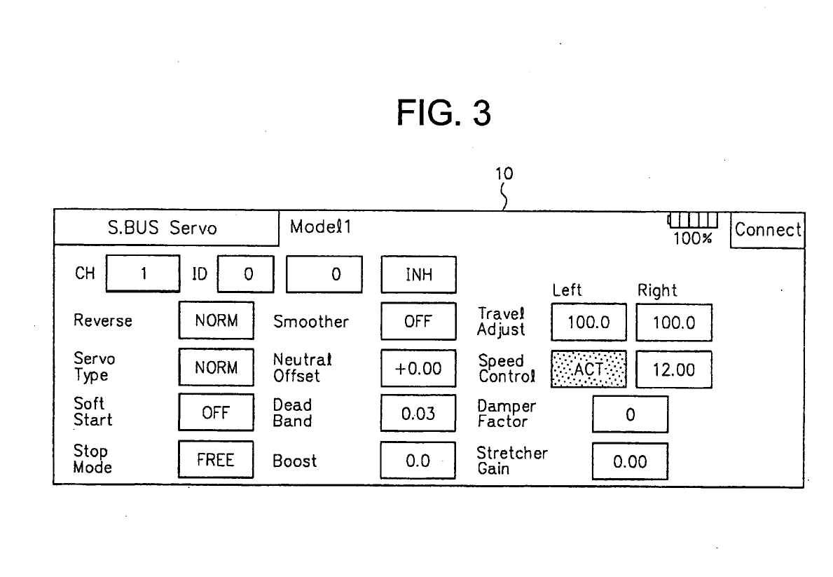

FIG. 3 illustrates a parameter setting screen shown in the display 10 of the controlling communication device 3. As shown in the screen, there are in the parameters for the servo motor 3a, an ID specifying a servo motor in which the parameter is set, a channel (CH) assigned to the servo motor, a servo reverse (Reverse) altering a rotation direction of the servo motor, a servo type (Servo Type) in which holding current becomes absent upon servo-stop during a given interval, and operation signal being inputted makes return to normal operation mode, a soft start (Soft Start) to limit a motion toward a designated position just when power is turned on, a stop mode (Stop Mode) to designate a state of the servo upon absence of an input signal of the servo, a smoother (Smoother) to smooth a motion of the servo, a neutral offset (Neutral Offset) to change neutral position, a speed control (Speed Control) to set a motion speed, a dead band (Dead Band) to designate an angle of dead band, a travel adjust (Travel Adjust) to set a maximum steering horizontal angle centering around the neutral, and a boost (Boost) to set a minimum current applied to an inner motor upon driving of the servo.

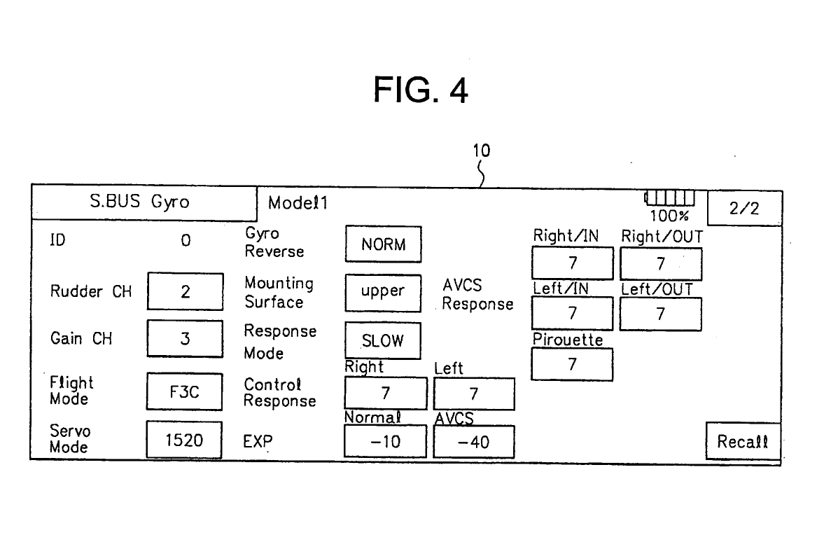

FIG. 4 shows a setting screen of the parameter shown, when changing the parameter of the gyroscope 3b, on the display 10 of the controlling communication device 4. The parameter of the gyroscope 3b includes, as shown in the screen, such an ID to specify a gyroscope the parameter is set to, a channel (Rudder CH, Gain CH) to designate the number of rudder channels and gain channels adapted to connect to the receiver, a flight mode (Flight Mode) to set a motion mode of F3D and 3D, a servo mode (Servo Mode) to select such a digital or analog type of serve, a gyroscope reverse (Gyro Reverse) to input a direction of the gyroscope, a amounting surface (Mounting Surface) to input a mounting surface of the gyroscope, a response mode (Response Mode) to select a reaction speed of the rudder, a control response (Control Response) to set a delay time of the rudder, an AVCS response (AVCS Response) to set a reaction speed of the tail, a pirouette feeling (Pirouette) to select an operation feeling upon operation of the rudder, an exp (EXP) to set an operation feeling close to the neutral of the rudder stick, a gain to set an AVCS sensibility, and a AVCS response (AVCS Response) to set a range defining an AVCS motion range.

After changing the parameter, the operator operates the operation part 9 to transmit the parameter signal from the controlling transceiver 11 through the antenna 11a as shown in FIG. 2. The parameter signal is received by the controlled side transceiver 15 of the controlled body communication device 5, and is checked by the identification flag determination part 15 whether to be the parameter signal. The controlled body side controller 12 then transmits the parameter signal to every device 3 (the servo motor 3a, the gyroscope 3b, and the sensor 3c). Each device 3 has a control device, but not shown, including a controller and a memory, by which the control device a necessary process is performed using the parameter signal transmitted from the controlled body side controller 12, and the parameter signal as reply signal is generated to output to the controlled body side controller 12. In each device 3, whether the identical information (CH, ID) of the device 3 included in the parameter signal and the its own identical information accord to each other is determined, and in only the according device 3, write command included in the parameter signal is executed using the parameter information. Namely, in the servo motor 3a designated by the identical information of the device 3 included in the parameter information, the designated parameter is modified according to the parameter information included in the parameter signal. Note that in the device 3 the identical information which does not accord to the identical information of the parameter signal, command is not executed even if receiving input of the parameter signal.

Furthermore, as shown in FIG. 2, when modification is performed in accordance with the command, the control device disposed in the servo motor 3a1 generates the parameter for replying including the modified parameter, and provides this with the controlled body side controller 12 to transmit from the controlled body side transceiver 15 to the controlling communication device 4. The parameter signal for transmitting includes information indicating pass or failure of the command, the identical information of the servo motor, and the parameter information written upon its pass.

Furthermore, as shown in FIG. 2, when the controlling communication device 4 receives the aforementioned replied parameter signal, the content thereof is displayed on the display 10, and the operator as soon as seeing of it, can thereby check pass or failure of the command and such values actually set.

As mentioned above, with reference to FIGS. 1 and 2, such flow of the signal has been discussed when rewriting the specified parameter of the specified servo motor 3a1 with the write command. In the case of command being different from this, namely, command being the read command, the parameter command to be transmitted from the controlling communication device 4 to the controlled body communication device 5 includes a specific ID information to the corresponding controlled body communication device 5, an identical flag for a signal type, an identical information (CH/ID) to the objective device 3, and a read command information. In the controlled body communication device 5 receiving the parameter signal, the controlled body side controller 12 transmits the parameter signal to every device 3. The device 3 of each of the devices 3, of which the identical information accords to the identical information (CH, ID) of the device 3 included in the parameter signal only executes the read command included in the parameter signal, and reads the designated parameter signal of the device 3 designated by the identical information. The reply parameter signal includes the parameter read from the designated device 3, and the identical information of the device 3. The reply parameter is transmitted from the controlled body communication device 5 to the controlling communication device 4, and is displayed on the display 10 of the controlling communication device 4, the operator, seeing it, soon checks pass or failure of the command and such the values of the specific parameter currently set in the designated device 3.

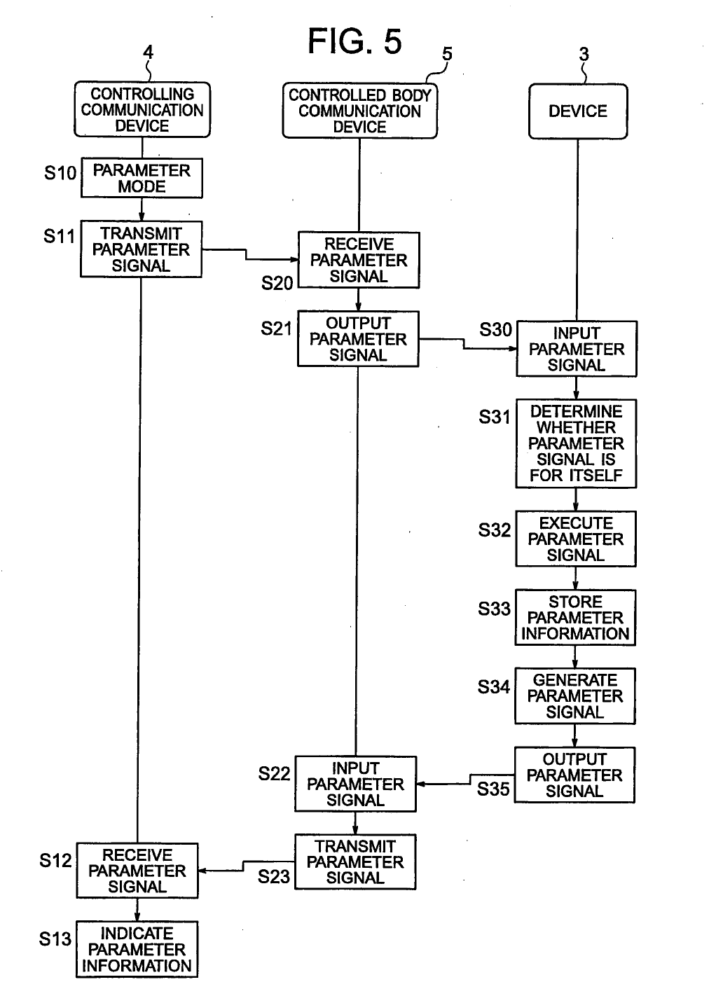

FIG. 5 is a flow diagram showing a work flow, in the case of the controlling communication system 1 set in the parameter mode, to manage, from the controlling communication device 4, the parameter of the device 3, namely, an operation procedure to modify the parameter of the device 3 and read the parameter, and also shows a sequence of each operation step performed in the controlling communication device 4, the controlled body communication device 5, and the device 3, and a flow of the signal and information swapping between each step. Modification and read of the parameter with the write and read command discussed with reference to FIGS. 1 and 2 will be again specifically discussed hereinafter with reference t FIG. 5. Note that configuration of each device should be referred to the reference sign in FIG. 1.

The controlling communication device 4 is set in the parameter mode (S10), and the specific parameter of the specific device 3 is modified on the parameter screen on the display 10, before the controlling side controller 7 controls the controlling side transceiver 11 to transmit the parameter signal (S11).

In the controlled body communication device 5 when the controlled body side transceiver 15 receives the parameter signal (S20), the controlled body side controller 12 outputs the parameter signal to every device 3.

When the parameter signal is inputted to each device 3 (S30), each device 3 determines whether or not the parameter signal designates itself by path or failure of the identical information (CH, or ID) (S31). The device 3 that determined the parameter signal designates itself executes the parameter signal (S32). Namely, the write or read command is executed using command information included in the parameter information and the parameter information included in accordance with the command. In the case of the write command made to modify the parameter, the designated device 3, after executing the command, stores the parameter information set in the device 3 in the memory of the controller (S33). Furthermore, the device 3 generates the parameter signal as the reply signal in the controller (S34), which is outputted to the controlled body side controller 12 of the controlled body communication device 5 (S35).

In the case of the command information being the write command, the parameter signal includes, as the reply signal, the information indicating pass or failure of the command, the identical information specifying the device 3, and the parameter information written upon pass. The parameter signal as reply signal thereof, upon command information being read signal, includes the parameter read out from the designated device 3, and the identical information specifying the device 3.

The parameter signal as reply signal inputted in the controlled body communication device 5 is then inputted to the controlled body side controller 12 of the controlled body communication device 15 (S22), and is transmitted to the controlling communication device 4 from the controlled body side transceiver (S23).

The parameter signal as reply signal is received by the controlling side transceiver 11 of the controlling communication device 4 (S12), and the controlling side controller 7 indicates the parameter information of the parameter signal on the display 10 (S13).

According to the embodiment discussed above, in the controlling communication system 1 configured to control the airframe 2 by radio between the controlling communication device 4 the operator controls, and the controlled body communication device 5 mounted in the airframe, it is made possible to readily modify and check parameters of the various device 3 mounted in the airframe 2 by radio. In addition to these features, it may be possible to provide an exclusive connection terminal for connecting by wire the device 3 with the controlling communication device 4, to connect by wire the controlling communication device 4 and the device 3, and to modify parameter of the device 3 by operating the controlling communication device 4 or reading out and checking the parameter set. Thereby, since when condition of radio receipt is bad, or the intended device 3 is limited, the controlling communication device can independently manage the parameter of the device 3 with wire without personal computer or programming box, and thereby the results can be brought that usability improves as the controlling communication system 1, and that convenience of usability is enhanced because of abundant choices for using methods.

Also, according to the embodiment discussed above, while the helicopter has been illustrated as the controlled body 2, an airplane is included as the controlled device 2 in which servo motor is mounted as the device 3 in which parameter can be set, furthermore in the case that a model car driven by the electric motor is included as the controlled body 2, an electric speed controller (ESC) is included as the device 3 in which relationship between an operational amount of the operation part 9 and a revolution of the motor is set.

As mentioned above, according to the controlling communication system 1, since it is made possible to freely select at the controlling communication device 4 side the operational mode for the device 2 and the parameter mode in which parameter of the device 3 mounted in the airframe 2 is managed, it is also made possible to readily modify and check parameter for various devices 3 with their mounted in the airframe 2, by setting in parameter mode, while checking necessary information on the display 10 of the controlling communication device 4 side without connection by wire. Therefore, the personal computer or the exclusive programming box is not required to modify the parameter for the device 3, and it is unnecessary to unload or detach the device 3 from the airframe 2, resolving such conventional complicated workability.

### REFERENCE SIGNS LIST

1 controlling communication system
2 controlled body (airframe)
3 devices
3a servo motor as device
3b gyroscope as device
3c sensor as device
4 controlling communication device
5 controlled body communication device
7 controlling side controller
11 controlling side transceiver
12 controlled body side controller
15 controlled body side transceiver

1. A controlling communication device, comprising:
(a) a controller operable to select a desired control mode from an operation mode for controlling a controlled body by controlling a device operable to set a parameter, and a parameter mode for managing the parameter of the device, wherein the device of the controlled device is mounted in the controlled body;
(b) a transceiver transmitting an operation signal to the controlled body in the operation mode, and transmitting a parameter signal to, and receiving the parameter signal from, the controlled body in the parameter mode by control of the controller; and
(c) an indicator indicating parameter information data in accordance with the parameter signal upon the controller in the parameter mode.

2. The controlling communication device as claimed in claim 1, wherein the parameter signal includes a write signal for transmitting the parameter information data destined to be set in the device of the controlled body to the controlled body, and a read signal for receiving the parameter information data set in the device of the controlled body from the controlled body.

3. A controlled body communication device disposed in a controlled body in which a device operable to set a parameter is mounted, and connected to the device, comprising:
a controller identifying an operation data for controlling the controlled body or a parameter information data of the device for managing the parameter of the device; and
a transceiver receiving an operation signal including the operation data, and transmitting and receiving a parameter signal including the parameter information data of the device by control of the controller.

4. The controlled body communication device as claimed in claim 3, wherein the parameter signal includes a write signal for receiving the parameter information data destined to be set in the device of the controlled body to the controlled body, and a read signal for transmitting the parameter information data set in the device of the controlled body from the controlled body.

5. A controlling communication system controlling a device mounted in a controlled body and operable to set parameter so as to operate the controlled body, the controlling communication system comprising:
a) a controlling communication device including
i) a controlling side controller operable to select a desired control mode from an operation mode for controlling the controlled body by controlling the device, and a parameter mode for managing a parameter of the device,
ii) a transceiver transmitting an operation signal to the controlled body in the operating mode, and transmitting a parameter signal to, and receiving the parameter signal from, the controlled body in the parameter mode by control of the controlling side controller, and
iii) an indicator indicating a parameter information data relevant to the parameter signal upon the controlling side controller in the parameter mode; and
b) a controlled body communication system including
iv) a controlled body side controller identifying an operation data of the controlled body relevant to the operating signal for controlling the controlled body, or a parameter information data relevant to the parameter signal for managing the parameter of the device;
v) a controlled body side receiver receiving the operation signal from the controlling communication device, and transmitting the parameter signal to, and receiving the parameter signal from the controlling communication device by control of the controlled body side controller.
